(19) United States
(12) Patent Application Publication
(10) Pub. No.: US 2025/0119397 A1
(43) Pub. Date: Apr. 10, 2025

(54) PRINT CONTROL DEVICE, PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Kohei YAMAMOTO, MATSUMOTO-SHI (JP); Takashi SERA, SHIOJIRI-SHI (JP); Masayuki KOBAYASHI, FUJIMI-MACHI (JP); Katsuhito KITAHARA, MATSUMOTO-SHI (JP)

(21) Appl. No.: 18/909,101

(22) Filed: Oct. 8, 2024

(30) Foreign Application Priority Data
Oct. 10, 2023 (JP) 2023-175032

(51) Int. Cl. H04L 51/02; G06F 3/12; H04L 51/18

(52) U.S. Cl. CPC H04L 51/02; G06F 3/1204; G06F 3/121; G06F 3/1237; G06F 3/1288; G06F 3/1293; H04L 51/18

(57) ABSTRACT

A print control device includes: a posting unit configured to post information about printing in a chat room; and a change instruction acquisition unit configured to acquire a change instruction inputted to the chat room and giving an instruction to change a posting language used in the chat t room, and when the change instruction is acquired, the posting unit changes the posting language from a first language used before the change instruction is acquired, to a second language, and then performs posting.

The present application is based on, and claims priority from JP Application Serial Number 2023-175032, filed Oct. 10, 2023, the disclosure of which is hereby incorporated by reference herein in its entirety.

### BACKGROUND

### 1. Technical Field

The present disclosure relates to a print control device, a processing method, and a non-transitory computer-readable storage medium storing a program.

### 2. Related Art

Recently, a chat service in which a message or the like is posted is in widespread use. Also, a chatbot that responds to a post from a user is known. In a system disclosed in JP-A-2021-60698, when a chatbot accepts a print instruction from a user via a chat service, processing to cause a printer to execute printing of a document is performed.

JP-A-2021-60698 is an example of the related art.

The user may want to change the language to use when chatting with the chatbot. In the system described in JP-A-2021-60698, the language for chat cannot be changed, resulting in poor convenience. Therefore, the provision of a technology that enables easy change of the language for chat is desired.

### SUMMARY

According to an aspect of the present disclosure, a print control device includes: a posting unit configured to post information about printing in a chat room; and a change instruction acquisition unit configured to acquire a change instruction inputted to the chat room and giving an instruction to change a posting language used in the chat room, and when the change instruction is acquired, the posting unit changes the posting language from a first language used before the change instruction is acquired, to a second language, and then performs posting.

According to another aspect of the present disclosure, a processing method by a device that performs posting in a chat room includes: acquiring a change instruction inputted to the chat room and giving an instruction to change a posting language used in the chat room; and when the change instruction is acquired, changing the posting language from a first language used before the change instruction is acquired, to a second language, and then performing posting in the chat room.

According to still another aspect of the present disclosure, a non-transitory computer-readable storage medium storing a program is provided, the program causing a computer to execute: a posting step of posting information about printing in a chat room; and a change instruction acquisition step of acquiring a change instruction inputted to the chat room and giving an instruction to change a posting language used in the chat room, and in the posting step, when the change instruction is acquired, the posting language is changed from a first language used before the change instruction is acquired, to a second language, and then posting is performed.

### BRIEF DESCRIPTION OF THE DRAWINGS

FIG. 1 is a block diagram showing an example of the configuration of an information processing system according to an embodiment.

FIG. 2 is a block diagram showing an example of the configuration of a print control device according to the embodiment.

FIG. 3 is a schematic diagram showing an example of transition of the screen of a terminal device when the posting language is changed.

FIG. 4 is a schematic diagram showing an example of the screen of the terminal device when the posting language is changed.

FIG. 5 is a schematic diagram showing an example of the screen of the terminal device when a user posts a print instruction in a chat room.

FIG. 6 is a flowchart showing an example of a flow of operations of the print control device according to the embodiment.

FIG. 7 is a schematic diagram showing an example of the terminal device when the posting language is changed.

### DESCRIPTION OF EMBODIMENTS

An embodiment will now be described with reference to the drawings. To clarify the explanation, suitable omissions and simplifications are made in the description and the drawings given below. In the drawings, the same elements are denoted by the same reference sign and a repeated description thereof is omitted where appropriate.

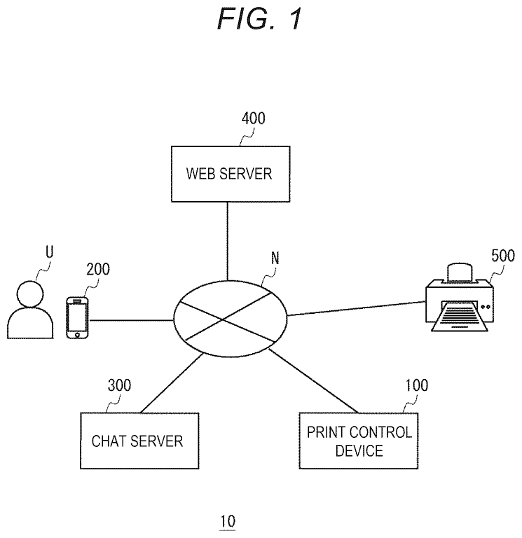

FIG. 1 is a block diagram showing an example of the configuration of an information processing system 10 according to an embodiment. In the example shown in FIG. 1, the information processing system 10 includes a terminal device 200, a chat server 300, a web server 400, a print control device 100, and an image forming device 500. The terminal device 200, the chat server 300, the web server 400, the print control device 100, and the image forming device 500 are connected to a network N such as the internet.

In this embodiment, the terminal device 200 is communicably connected at least to the chat server 300. The print control device 100 is communicably connected at least to the chat server 300, the web server 400, and the image forming device 500. However, when a file existing in the web server 400 need not be printed, the information processing system 10 may not include the web server 400.

The terminal device 200 is a device operated by a user U and is, for example, a smartphone, a tablet terminal, a personal computer or the like. In the terminal device 200, application software (also referred to as a chat app) to use a chat service provided by the chat server 300 is installed. The user U is a user having an account to use the chat service and can use the chat service, using the terminal device 200. The account includes identification information to identify the user, and other information associated with the identification information. Specifically, for example, the account includes a password or the like in addition to the user ID. While one terminal device 200 and one user U are illustrated in FIG. 1, a plurality of users can use the information processing system 10. Therefore, the information processing system 10 can include a plurality of the terminal devices 200.

The chat server 300 is a server providing a chat service. The chat server 300 may be formed of a plurality of servers. The chat service enables members participating in the same chat room to place a post and thus chat among the members. The chat room is a virtual space where members exchange postings. The chat room is also referred to as a talk room, a channel, or a workspace. In this embodiment, when the user U makes an input to a chat room in which the print control device 100 participates as a member, the chat server 300 transmits the content of the input to the chat room along with the identification information of the user U making the input, to the print control device 100. Therefore, the print control device 100 receives the identification information of the user U making the input and the content of the input from the chat server 300. The input to the chat room by the user U may be a posting of a text or a file in the chat room, may be a function call instruction or a change instruction, described later, or may be a print instruction. The input (posting) to the chat room by the user U is carried out using the terminal device 200 and therefore can also be said to the input (posting) to the chat room by the terminal device 200.

The print control device 100 is a device that functions as a chatbot. The chatbot is a software robot that receives data posted in the chat service and performs processing corresponding to the data. The print control device 100 has an account to use the chat service and participates as a member in the chat room in which the user U participates as a member. The print control device 100 also performs processing to cause the image forming device 500 to print a file. The print control device 100 is, for example, a server, but is not limited to the server and may be any device having functions of a computer. The print control device 100 may be formed of a plurality of computers (a plurality of servers). The print control device 100 may be referred to as an information processing device.

The web server 400 is a server where any file that can be a file to be printed exists. The web server 400 may be a cloud storage storing a file. In this embodiment, a print control unit 114, described later, of the print control device 100 may acquire a file to be printed from the web server 400, for example, using a uniform resource locator (URL) posted in the chat room.

The image forming device 500 is a device having a function of performing print processing and is specifically, for example, a printer. The image forming device 500 is registered in advance with the print control device 100 as an image forming device to be used for printing. While one image forming device 500 is illustrated in FIG. 1, a plurality of the image forming devices 500 may be registered with the print control device 100 as image forming devices available for printing. For example, with the print control device 100, an image forming device 500 may be registered for each user U. In this embodiment, the print control device 100 causes the image forming device 500 associated with the account of the user U to print a file designated by the user U as a file to be printed.

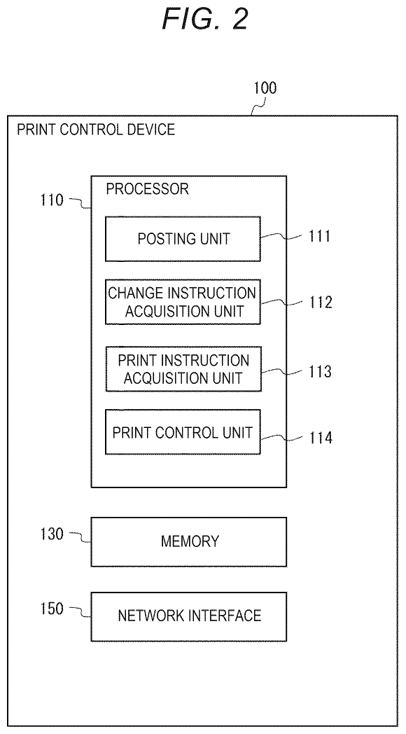

The specific configuration of and processing by the print control device 100 will now be described. FIG. 2 is a block diagram showing an example of the configuration of the print control device 100. As shown in FIG. 2, the print control device 100 has a processor 110, a memory 130, and a network interface 150. In this way, the print control device 100 has functions of a computer.

The network interface 150 is used to communicate via the network N. The network interface 150 may include, for example, a network interface card (NIC).

The memory 130 is formed of, for example, a combination of a volatile memory and a nonvolatile memory. The memory 130 is used to store a program executed by the processor 110 and data or the like used for various processing.

The processor 110 reads out a program from the memory 130 and executes the program. The processor 110 thus implements functions of a posting unit 111, a change instruction acquisition unit 112, a print instruction acquisition unit 113, and the print control unit 114, which will be described later. The processor 110 may be, for example, a microprocessor, a microprocessor unit (MPU), or a central processing unit (CPU) or the like. The processor 110 may include a plurality of processors.

The program includes a command set (or software code) to cause a computer to execute one or more functions described in the embodiment, when read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or other memory techniques, a CD-ROM, a digital versatile disc (DVD), a Blu-ray (trademark registered) disc or other optical disc storages, a magnetic cassette, a magnetic tape, a magnetic disk storage or other magnetic storage devices. The program may be transmitted on a transitory computer-readable medium or a communication medium. Examples of the transitory computer-readable medium or the communication medium include, but are not limited to, electrical, optical, acoustic or other forms of propagation signals.

The posting unit 111, the change instruction acquisition unit 112, the print instruction acquisition unit 113, and the print control unit 114 will now be described.

The posting unit 111 posts data (information) of a text or the like in the chat room in which the print control device 100 participates as a chatbot. Specifically, the posting unit 111 transmits data to be posted to the chat server 300. For example, the posting unit 111 posts information about printing in the chat room. The information about printing may be a message prompting the user U to input an instruction about the execution of printing or the setting of printing, or may be a response message to an instruction by the user U about the execution of printing or the setting of printing. These are simply examples of the information about printing, and the information about printing is not limited to the above information. Therefore, the information about printing posted by the posting unit 111 includes any information about printing such as an advertisement about a print service. The posting unit 111 may also post various other information than the information about printing. Also, particularly in this embodiment, the posting unit 111 executes predetermined processing when the user inputs a change instruction for a posting language or a function call instruction, to the chat room. The processing by the posting unit 111 when a change instruction or a function call instruction is inputted to the chat room will be described later. The posting language refers to a natural language used when the print control device 100 as a chatbot performs posting in the chat room. The posting language can also be said to be a natural language displayed in the chat room. The posting unit 111 performs posting, using a predetermined natural language (for example, Japanese) as the default posting language.

The change instruction acquisition unit 112 acquires an instruction about change of the posting language, inputted to the chat room in which the print control device 100 participates as a chatbot. In this embodiment, the change instruction acquisition unit 112 acquires a function call instruction or a change instruction inputted to this chat room. The function call instruction is an instruction to call a posting language change function. Since a candidate language that can be set as the posting language is called by the function call instruction, as will be described later, the function call instruction may be referred to as a candidate call instruction. The function call instruction is posted in the chat room by the user U. In this embodiment, the function call instruction is a text including a keyword that is predetermined as a keyword meaning the function call instruction. As the text including this keyword is posted in the chat room, the change instruction acquisition unit 112 acquires the function call instruction. For example, when the user U posts a text of “posting language setting” in the chat room, the change instruction acquisition unit 112 acquires this text as the function call instruction. The change instruction is an instruction to change the posting language used in the chat room and is inputted to the chat room by the user U. In this embodiment, for example, the change instruction is a selection operation to a posting language option provided via an input form posted by the posting unit 111 in response to the function call instruction. That is, as the user U selects a posting language option displayed in the chat room, the change instruction acquisition unit 112 acquires the change instruction.

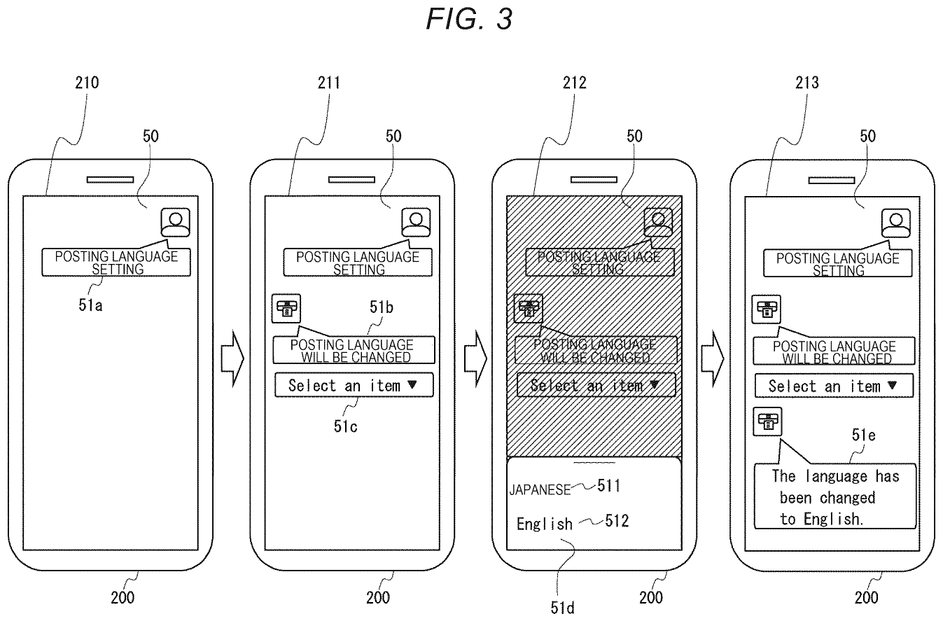

The processing by the posting unit 111 and the change instruction acquisition unit 112 will now be described with reference to FIG. 3. FIG. 3 is a schematic diagram showing an example of transition of the screen of the terminal device 200 when the posting language is changed. In the example shown in FIG. 3, the posting language before change is Japanese and the posting language is changed to English by an operation of the user U. When the user U wants to change the posting language currently used by the print control device 100 as a chatbot, the user U inputs a function call instruction to a chat room 50 in which the user U and the print control device 100 participate. Specifically, the user U operates the terminal device 200 and thus performs posting of a text 51a of the function call instruction to the chat room 50. In the example shown in FIG. 3, the posting of the text 51a is done in Japanese, but when a keyword in another language is used as the keyword meaning the function call instruction, the function call instruction may be posted in another language than Japanese.

In FIG. 3, a screen 210 shows a screen where the chat room 50 as of when the text 51a as the function call instruction is posted is displayed. In this way, the function call instruction by the user U is an instruction inputted to the chat room 50, using the terminal device 200, and therefore may be referred to as the function call instruction from the terminal device 200 or may be referred to as the function call instruction by the terminal device 200, or the like. When the function call instruction is inputted to the chat room 50, the change instruction acquisition unit 112 acquires this function call instruction via the chat service. That is, the change instruction acquisition unit 112 acquires, from the chat server 300, the function call instruction inputted to the chat room 50 in which the user U and the print control device 100 as a chatbot participate.

When the change instruction acquisition unit 112 acquires the function call instruction, the posting unit 111 posts a candidate language that can be used as the posting language in the chat room 50. Thus, the user U can perform an operation to change the posting language even without knowing in advance the posting language that can be set. Specifically, the posting unit 111 posts a predetermined input form 51c in the chat room 50. This predetermined input form 51c is an input form that provides, as options, candidate languages which can be used as the posting language, and that accepts an input to select one of the options. The input form may be described in the currently set posting language or may be described in a predetermined language. In FIG. 3, a screen 211 shows a screen where the chat room 50 as of when the input form 51c is posted by the posting unit 111 is displayed. As shown in the screen 211, when the change instruction acquisition unit 112 acquires the function call instruction, the posting unit 111 may post a response message 51b to the function call instruction, in the currently set posting language, that is, in the currently used posting language, in the chat room 50. In the example shown in FIG. 3, the posting of the response message 51b is done in Japanese and is the posting of a message “Posting language will be changed”. As the posting unit 111 posts the response message in this way, the user U can properly recognize the progress of posting language change procedures.

When the candidate languages that can be used as the posting language are posted in the chat room 50, the user U makes an input to designate one of the candidate languages, to the chat room 50. Specifically, the user U performs an operation to select one of the options provided by the input form 51c, at the terminal device 200. That is, the selection of an option by the user U is inputted as a change instruction to the chat room 50. In FIG. 3, a screen 212 shows a screen where a list 51d of options provided by the input form 51c is displayed. The list 51d is included in the input form 51c. Therefore, the list 51d is posted in the chat room 50 as a part of the input form 51c. The list 51d is displayed, for example, by performing a predetermined operation (for example, a tap or a click or the like) on the input form 51c. In the example shown in FIG. 3, the list 51d includes a first option 511 and a second option 512. Specifically, the first option 511 is an option to select the use of Japanese as the posting language, and the second option 512 is an option to select the use of English as the posting language. In the example shown in FIG. 3, Japanese and English are given as candidates for the posting language, but another natural language may be given as a candidate for the posting language, and the natural languages that can be set as the posting language may be three or more languages. The user U performs an operation to select one of the options given in the list 51d. That is, the user U performs an operation to select a language to use as the posting language. In the example shown in FIG. 3, the user U performs an operation to select the second option 512 (that is, English). Specifically, the user U performs a predetermined operation (for example, a tap or a click or the like) on the second option 512. Thus, an input to select one of the candidates for the posting language is inputted to the chat room 50. In this way, the change instruction by the user U is an instruction inputted to the chat room 50, using the terminal device 200, and therefore may be referred to as the change instruction from the terminal device 200 or may be referred to as the change instruction by the terminal device 200, or the like. When the change instruction is inputted to the chat room 50, the change instruction acquisition unit 112 acquires this change instruction via the chat service. That is, the change instruction acquisition unit 112 acquires the change instruction inputted to the chat room 50 in which the user U and the print control device 100 as a chatbot participate, from the chat server 300. In the example shown in FIG. 3, the change instruction inputted to the chat room 50 is acquired by the change instruction acquisition unit 112 as a change instruction to change the posting language to English. In this way, the change instruction acquisition unit 112 acquires an input to designate one of the candidate languages, as a change instruction. Particularly in the example shown in FIG. 3, the designation of a language by the user U is performed by a selection operation to select an option provided by the input form 51c. With such a configuration, the user can change the posting language by a simple operation.

When the change instruction acquisition unit 112 acquires the change instruction, the posting unit 111 changes the posting language. That is, the posting unit 111 changes the setting of the posting language. Specifically, the posting unit 111 changes the posting language to a natural language specified based on the change instruction. More specifically, the posting unit 111 changes the posting language in the chat room used to chat with the user U inputting the change instruction. Particularly in this embodiment, the posting unit 111 uses the language designated by the change instruction, as the posting language. More specifically, the posting unit 111 uses the language selected in the change instruction, as the posting language. That is, the posting unit 111 performs various postings, using the posting language newly set in response to the acquisition of the change instruction. In FIG. 3, a screen 213 shows a screen where the chat room 50 after the change instruction acquisition unit 112 acquires the change instruction is displayed. As shown in the screen 213, when the change instruction acquisition unit 112 acquires the change instruction, the posting unit 111 may post a response message 51e to the change instruction, in the posting language after change, that is, in the newly set posting language, in the chat room 50. In this case, specifically, for example, the response message 51e notifying that the posting language is changed is posted. In the example shown in FIG. 3, the posting of the response message 51e is done in English. As the posting unit 111 posts the response message in this way, the user U can easily recognize that the posting language is properly changed.

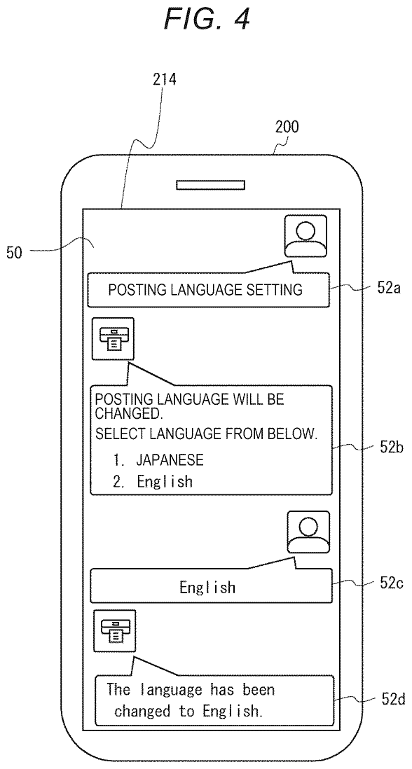

In the above example, when the change instruction acquisition unit 112 acquires a function call instruction, the posting unit 111 posts a predetermined input form including a candidate language as an option, but the posting unit 111 may not necessarily post such an input form. For example, as shown in FIG. 4, the posting unit 111 may simply post a text 52b notifying the user U of candidate languages that can be used as the posting language, in the chat room 50. FIG. 4 is a schematic diagram showing another example of the screen of the terminal device 200 when the posting language is changed. In the example shown in FIG. 4, the posting language before change is Japanese and the posting language is changed to English by the operation of the user U. In FIG. 4, a screen 214 shows a screen where the chat room 50 after the change instruction acquisition unit 112 acquires a change instruction is displayed. In the example shown in FIG. 4, when a text 52a of the function call instruction by the user U is posted, the posting unit 111 posts the text 52b notifying the user U of candidate languages that can be used as the posting language, as shown in the screen 214. In the example shown in FIG. 4, the posting of the text 52a and the posting of the text 52b are done in Japanese but may be done in another language. The text 52b may also be referred to as a response message to the function call instruction. In the example shown in FIG. 4, specifically, the text 52b “Posting language will be changed. Select language from below. 1. Japanese 2. English” is posted in Japanese. The name of a candidate language (that is, option) described in the text 52b may be described in this language. That is, as shown in FIG. 4, the first candidate (option) is described as “1. Japanese” in Japanese, and the second candidate (option) is described as “2. English” in English. When the text 52b is posted, the user U performs an operation of posting a text 52c specifying one of the candidate languages in the chat room 50. That is, the user U posts the text 52c specifying the language to use as the posting language in the chat room 50. The text 52c specifying the language to use as the posting language, posted immediately after the text 52b, is acquired by the change instruction acquisition unit 112 as a change instruction. That is, the text 52c is acquired by the change instruction acquisition unit 112 as the change instruction to change the posting language to the language specified by the text 52c. In the example shown in FIG. 4, the user U posts the text 52c “English”. The post as the change instruction by the user U may be any post that can specify the language to use as the posting language from the candidate languages, and may be not necessarily the posting of the name of the language. For example, when an identifier such as a number corresponding to each candidate language is given, the user U may post the identifier corresponding to the language as the change instruction. For example, in the example shown in FIG. 4, the user U wanting to change the posting language to English may post “2”. In this way, the designation of the language by the user U may be performed by placing a post in the chat room 50 that specifies one of the candidate languages. With such a configuration, the posting language can be changed without using the input form. In the example shown in FIG. 4, since the change instruction to change the posting language to English is acquired by the change instruction acquisition unit 112, the posting unit 111 posts a response message 52d to the change instruction, in English in the chat room 50.

When the change of the posting language according to the change instruction acquired by the change instruction acquisition unit 112 fails for some reason, the posting unit 111 may post error information in the currently set posting language in the chat room 50. This error information may include information indicating the cause of the failure in change of the posting language. For example, when the user U posts a text that does not clearly designate any one of the candidate languages in response to the text 52b posted by the posting unit 111, the change of the posting language fails. In this case, the posting unit 111 may post the error information in the currently set posting language (in the example shown in FIG. 4, Japanese). While the posting of the error information is described with reference to FIG. 4 as an example, the error information may be posted when the change instruction inputted using the foregoing input form is acquired by the change instruction acquisition unit 112 and the change of the posting language fails for some reason. As the error information is posted in this way, the user U can easily recognize the failure in the change of the posting language.

The description goes back to the configuration of the print control device 100 shown in FIG. 2. The print instruction acquisition unit 113 acquires a print instruction posted in the chat room 50. That is, the print instruction acquisition unit 113 acquires the print instruction to print a file from the chat server 300. The print instruction may include information specifying a file to be printed. The information specifying a file to be printed may be the file to be printed itself, the URL of the file to be printed, or the file path of the file to be printed. For example, the print instruction acquisition unit 113 may acquire a print instruction to print a file existing in the web server 400 or may acquire a print instruction to print a file existing in the terminal device 200. The user U operates the terminal device 200 to post the print instruction in the chat room 50 in which the print control device 100 participates as a chatbot. In this way, the print instruction by the user U is an instruction given using the terminal device 200 and therefore may be referred to as the print instruction from the terminal device 200 or may be referred to as the print instruction by the terminal device 200, or the like.

The print control unit 114 causes the image forming device 500 to execute the printing of the file for which the instruction to print is given by the print instruction acquired by the print instruction acquisition unit 113. The print control unit 114 causes the image forming device 500 corresponding to the identification information of the user U giving the print instruction, to execute the printing of the file. The print control unit 114 may cause the image forming device 500 to execute the printing via another device (for example, a server) that manages or controls the printing by the image forming device 500, instead of directly instructing the image forming device 500 to print.

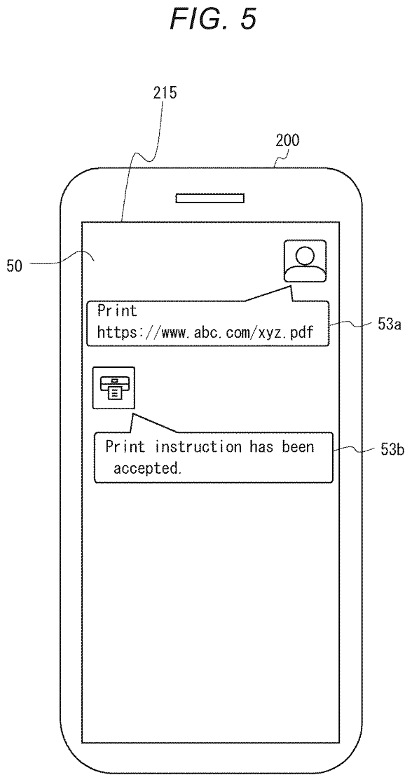

FIG. 5 is a schematic diagram showing an example of the screen of the terminal device 200 when the user U posts the print instruction the chat room 50. Particularly in FIG. 5, a screen 215 shows a screen where the chat room 50 after the posting language of the print control device 100 as a chatbot is changed from Japanese to English in response to the change instruction illustrated in FIG. 3 or FIG. 4 is displayed. In the example shown in FIG. 5, first, the user U posts a message 53a that is a print instruction, in the chat room 50, using the terminal device 200. The message 53a is posted, for example, in the same language as the posting language used by the print control unit 114 but may be in a different language from this posting language. In the example shown in FIG. 5, the message 53a is a print instruction described as an English text and includes a keyword “Print” indicating printing and information specifying the file to be printed (more specifically, the URL of the file to be printed). The message 53a is acquired by the print instruction acquisition unit 113 as a print instruction. The print control unit 114 acquires the file for which the instruction to print is given by the print instruction, and causes the image forming device 500 to execute the printing of this file. Thus, the image forming device 500 prints the file. As shown in FIG. 5, the posting unit 111 may post a response message 53b to the print instruction, in the chat room 50. This post is placed in the posting language changed according to the change instruction (in the example shown in FIG. 5, English). In this way, in this embodiment, the language for the posting about printing by the chatbot can be changed to a language desired by the user U.

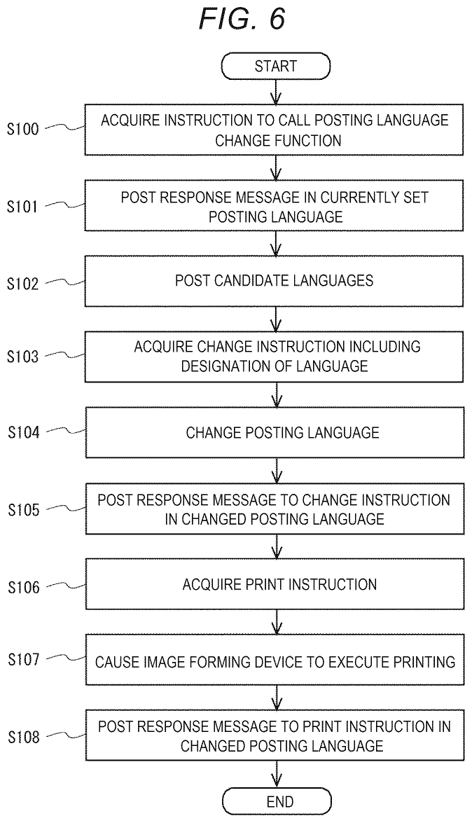

An example of operations of the print control device 100 will now be described. FIG. 6 is a flowchart showing an example of a flow of operations of the print control device 100. The flowchart of FIG. 6 shows a flow of operations of the print control device 100 when the user U performs an operation of giving an instruction to print after performing an operation of changing the posting language, using the terminal device 200. An example of a flow of operations of the print control device 100 will now be described with reference to FIG. 6.

In step S100, in response to the posting by the user U of a function call instruction, which is an instruction to call the posting language change function, in the chat room 50, the change instruction acquisition unit 112 acquires this function call instruction via the chat server 300.

Next, in step S101, the posting unit 111 posts a response message to the function call instruction, in the currently set posting language in the chat room 50. The posting of this response message may be omitted.

Next, in step S102, the posting unit 111 posts candidate languages that can be used as the posting language, in the chat room 50. As described above with reference to FIG. 3, the posting unit 111 may provide candidate languages that can be used as the posting language, as options, and may post an input form that accepts an input to select one of the options. Also, as described above with reference to FIG. 4, the posting unit 111 may post a text notifying the user U of candidate languages that can be used as the posting language, instead of posting the input form.

After step S102, in step S103, the change instruction acquisition unit 112 acquires a change instruction including the designation of a language by the user U. When the input form is posted in step S102, the selection of an option by the user U from the options provided by the input form is acquired as the change instruction. When the text notifying the user of candidate languages that can be used as the posting language is posted in step S102, the posting of a text specifying one of the candidate languages is acquired as the change instruction.

After step S103, in step S104, the posting unit 111 changes the posting language. Specifically, from this step onward, the posting unit 111 uses the language designated by the change instruction acquired in step S103, as the posting language. In step S105, the posting unit 111 posts a response message to the change instruction, in the changed posting language in the chat room 50. The posting of this response message may be omitted.

After that, in step S106, in response to the posting of a print instruction in the chat room 50 by the user U, the print instruction acquisition unit 113 acquires this print instruction via the chat server 300. As the print instruction acquisition unit 113 acquires the print instruction, the print control unit 114 in step S107 acquires a file for which an instruction to print is given by the print instruction, and causes the image forming device 500 to execute the printing of this file. In step S108, the posting unit 111 posts a response message to the print instruction, in the changed posting language in the chat room 50. This response message may be a message notifying the user of the result of execution of the printing. The posting of this response message may be omitted.

An embodiment has been described above. In this embodiment, when a change instruction inputted to the chat room is acquired, the posting unit 111 changes the posting language from the first language used before the change instruction is acquired, to the second language, and then performs posting. That is, the posting language is changed in response to the change instruction inputted to the chat room. Therefore, according to this embodiment, the language for chat can be easily changed.

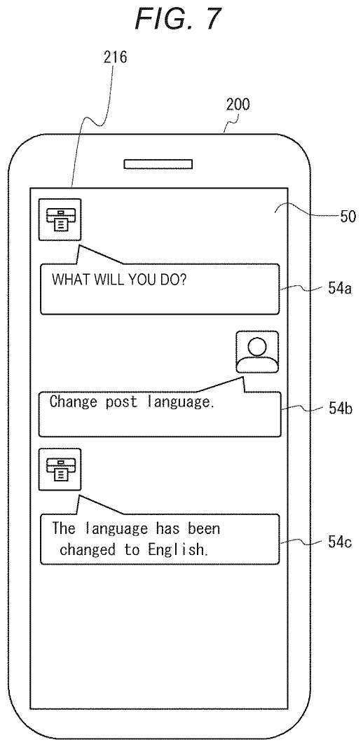

While an embodiment has been described above, the present disclosure is not limited to the above embodiment and suitable changes can be made without departing from the spirit and scope of the present disclosure. For example, in the above embodiment, the function call instruction is acquired before the acquisition of the change instruction, but the function call instruction may be not necessarily acquired. For example, when the language of the change instruction posted in the chat room is different from the currently set posting language, the posting unit 111 may change the posting language to the language of the change instruction. This will now be described further with reference to a drawing. FIG. 7 is a schematic diagram showing an example of the screen of the terminal device 200 when the posting language is changed. In the example shown in FIG. 7, the posting language before change is Japanese and the posting language is changed to English by an operation of the user U. In FIG. 7, a screen 216 shows a screen where the chat room 50 after the change instruction acquisition unit 112 acquires a text 54b as a change instruction is displayed. In the example shown in FIG. 7, the user U posts the text 54b of the change instruction in English in the chat room 50 in the state where Japanese is used as the posting language. This change instruction may be a predetermined keyword that gives an instruction to change the posting language and that is described in one of the languages that can be set as the posting language. Which language is used as the posting language by the user U can be determined by known natural language processing. In the example shown in FIG. 7, the text 54b as the change instruction is a text including English keywords “Change posting language”. The change instruction given in English is acquired by the change instruction acquisition unit 112. In this case, the posting unit 111 changes the posting language from Japanese, which is currently used, to English, and then performs posting. For example, as shown in FIG. 7, the posting unit 111 posts a response message 54c to the change instruction, in English. With such a configuration, the number of chats for the change of the posting language is fewer than in the above embodiment and therefore the posting language can be changed swiftly. Thus, the convenience for the user is improved. In FIG. 7, the posting unit 111 posts a text 54a “What will you do?” in Japanese, but this posting may be omitted.

When a text including a predetermined keyword (for example, “Posting language change” or the like) as a keyword meaning the change instruction is posted in the chat room, the change instruction acquisition unit 112 may acquire this text as the change instruction and the posting unit 111 may change the posting language to a predetermined language. In this case, the language of the change instruction may be different from the predetermined language. For example, the user U posts a text “Posting language change” in Japanese in the chat room. In this case, the change instruction acquisition unit 112 acquires this text as the change instruction and the posting unit 111 changes the posting language to the predetermined language (for example, English). In this way, when the change instruction is acquired, the posting unit 111 may change the posting language to the predetermined language and then perform posting. The change instruction may include a keyword specifying a language in addition to the predetermined keyword as the keyword meaning the change instruction. For example, a text such as “Change posting language to English” may be used as the change instruction. In this case, the posting unit 111 may change the posting language to the language specified by the change instruction. In this way, when the change instruction is acquired, the posting unit 111 may change the posting language to the language designated by the change instruction and then perform posting. Also, in the above embodiment, only the posting language is changed in response to the change instruction, but the language of another processing may be changed as well. For example, when the print control device 100 has a transmission processing unit or the like that performs processing of transmitting information (for example, emails, data of web pages or the like) directly to the terminal device 200 without using the chat server 300, the language of the transmitted information may be changed, too, in response to the change instruction.

A part or all of the above embodiment can be described as in the appendices given below but is not limited thereto.

### Appendix 1

A print control device includes: a posting unit configured to post information about printing in a chat room; and a change instruction acquisition unit configured to acquire a change instruction inputted to the chat room and giving an instruction to change a posting language used in the chat room, and when the change instruction is acquired, the posting unit changes the posting language from a first language used before the change instruction is acquired, to a second language, and then performs posting.

### Appendix 2

In the print control device according to Appendix 1, the change instruction acquisition unit acquires a function call instruction, which is an instruction to call a posting language change function, posted in the chat room before the change instruction is acquired; the posting unit posts candidate languages that can be used as the posting language in the chat room when the function call instruction is acquired; the change instruction acquisition unit acquires an input designating one of the candidate languages, as the change instruction; and the posting unit uses the second language, which is the language designated by the change instruction, as the posting language.

### Appendix 3

In the print control device according to Appendix 2, the posting unit provides candidate languages that can be used as the posting language, as options, and posts an input form that accepts an input to select one of the options, in the chat room, and the designation is performed by a selection operation from the options provided by the input form.

### Appendix 4

In the print control device according to Appendix 2, the designation is performed by a posting that specifies one of the candidate languages, in the chat room.

### Appendix 5

In the print control device according to one of Appendices 2 to 4, the posting unit posts a response message to the function call instruction, in the first language in the chat room.

### Appendix 6

In the print control device according to one of Appendices 1 to 5, the posting unit posts a response message to the change instruction, in the second language in the chat room.

### Appendix 7

In the print control device according to one of Appendices 1 to 6, when a language of the change instruction posted in the chat room is different from the first language, the posting unit changes the posting language from the first language to the second language, which is the language of the change instruction, and then performs posting.

### Appendix 8

The print control device according to one of Appendices 1 to 7 further includes a print instruction acquisition unit configured to acquire a print instruction posted in the chat room, and the posting unit posts a response message to the print instruction, in the second language in the chat room.

### Appendix 9

In the print control device according to one of Appendices 1 to 8, when a change of the posting language according to the change instruction fails, the posting unit posts error information in the first language in the chat room.

### Appendix 10

A processing method by a device that performs posting in a chat room includes: acquiring a change instruction inputted to the chat room and giving an instruction to change a posting language used in the chat room; and when the change instruction is acquired, changing the posting language from a first language used before the change instruction is acquired, to a second language, and then performing posting in the chat room.

### Appendix 11

A non-transitory computer-readable storage medium storing a program is provided, the program causing a computer to execute: a posting step of posting information about printing in a chat room; and a change instruction acquisition step of acquiring a change instruction inputted to the chat room and giving an instruction to change a posting language used in the chat room, and in the posting step, when the change instruction is acquired, the posting language is changed from a first language used before the change instruction is acquired, to a second language, and then posting is performed.

What is claimed is:

1. A print control device comprising:
a posting unit configured to post information about printing in a chat room; and
a change instruction acquisition unit configured to acquire a change instruction inputted to the chat room and giving an instruction to change a posting language used in the chat room, wherein
when the change instruction is acquired, the posting unit changes the posting language from a first language used before the change instruction is acquired, to a second language, and then performs posting.

2. The print control device according to claim 1, wherein
the change instruction acquisition unit acquires a function call instruction, which is an instruction to call a posting language change function, posted in the chat room before the change instruction is acquired;
the posting unit posts candidate languages that can be used as the posting language in the chat room when the function call instruction is acquired;
the change instruction acquisition unit acquires an input designating one of the candidate languages, as the change instruction; and
the posting unit uses the second language, which is the language designated by the change instruction, as the posting language.

3. The print control device according to claim 2, wherein
the posting unit provides candidate languages that can be used as the posting language, as options, and posts an input form that accepts an input to select one of the options, in the chat room, and
the designation is performed by a selection operation from the options provided by the input form.

4. The print control device according to claim 2, wherein
the designation is performed by a posting that specifies one of the candidate languages, in the chat room.

5. The print control device according to claim 2, wherein
the posting unit posts a response message to the function call instruction, in the first language in the chat room.

6. The print control device according to claim 1, wherein
the posting unit posts a response message to the change instruction, in the second language in the chat room.

7. The print control device according to claim 1, wherein
when a language of the change instruction posted in the chat room is different from the first language, the posting unit changes the posting language from the first language to the second language, which is the language of the change instruction, and then performs posting.

8. The print control device according to claim 1, further comprising:
a print instruction acquisition unit configured to acquire a print instruction posted in the chat room, wherein
the posting unit posts a response message to the print instruction, in the second language in the chat room.

9. The print control device according to claim 1, wherein
when a change of the posting language according to the change instruction fails, the posting unit posts error information in the first language in the chat room.

10. A processing method by a device that performs posting in a chat room, the method comprising:
acquiring a change instruction inputted to the chat room and giving an instruction to change a posting language used in the chat room; and
when the change instruction is acquired, changing the posting language from a first language used before the change instruction is acquired, to a second language, and then performing posting in the chat room.

11. A non-transitory computer-readable storage medium storing a program, the program causing a computer to execute:
a posting step of posting information about printing in a chat room; and
a change instruction acquisition step of acquiring a change instruction inputted to the chat room and giving an instruction to change a posting language used in the chat room, wherein
in the posting step, when the change instruction is acquired, the posting language is changed from a first language used before the change instruction is acquired, to a second language, and then posting is performed.
